(19) United States
(12) Patent Application Publication
(10) Pub. No.: US 2004/0048749 A1
(43) Pub. Date: Mar. 11, 2004

(54) Microencapsulated biologically active substances that contain a water-soluble or water-dispersible comb polymer

(76) Inventors: Ralf Zerrer, Karlstein (DE); Roman Morschhauser, Mainz (DE)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/467,044

(22) PCT Filed: Jan. 23, 2002
(86) PCT No.: PCT/EP02/00615

(30) Foreign Application Priority Data
Feb. 3, 2001 (DE) 10104991.9

(51) Int. Cl. A01N 25/28

(52) U.S. Cl. 504/359

(57) ABSTRACT

Microencapsulated biologically active compounds comprising a water-soluble or water-dispersible comb polymer.

Microencapsulated biologically active compounds comprising a water-soluble or water-dispersible comb polymer consisting of a main polymer chain and polyester side arms which carry sulfonic acid groups and are attached to the main polymer chain via ester groups.

For economical and ecological reasons, the controlled release of biologically active substances is an important target for agricultural industry. Using microencapsulation of the active substances, it is possible to maintain the concentration required for biological activity at the site of action for a prolonged period of time, to improve the stability of the substances, to reduce environmental stress, to lower the acute toxicity of the compositions and to circumvent incompatibilities with other components of the formulation.

Various techniques for microencapsulating substances are known. The basic principle is to coat a water-insoluble or water-soluble biologically active compound, for example an acaricide, bactericide, fungicide, herbicide, insecticide, molluscicide, nematicide or rodenticide, or a water-insoluble or water-soluble mixture comprising a biologically active compound with a polymer, for example a polyurea, polyurethane, polyacrylate, polyester, etc.

U.S. Pat. No. 4,285,720 describes the microencapsulation of water-immiscible substances. Here, the wall of the capsule consists of a polyurea formed from a polyisocyanate.

WO 99/11122 describes a process for microencapsulating a water-insoluble herbicide which comprises dispersing a mixture of triisocyanates, diisocyanates and a water-insoluble herbicide in an aqueous solution containing a colloid, adding a low-molecular-weight polyamine to the oil-in-water emulsion and polymerizing at temperatures above 40° C., resulting in the formation of a coat around the active compound.

WO 98/28975 describes a process for microencapsulating water-soluble active compounds which comprises dispersing a urea/formaldehyde mixture and/or a melamine formaldehyde, prepolymers and a water-soluble active compound in a continuous organic phase consisting of one or more organic solvents and one or more emulsifiers. At temperatures of from 20 to 100° C., the prepolymers contained in the aqueous phase condense at the phase interface in the presence of surface-active proton donors which are soluble in the organic phase but only sparingly soluble in the aqueous phase, resulting in the formation of a solid capsule wall which surrounds the aqueous droplets.

It has now been found that water-soluble and/or water-dispersible comb polymers consisting of a polyacrylic-acid-containing main polymer chain and sulfone-containing polyester side chains are highly suitable for use as protective colloids in microencapsulation processes by “in-situ polymerization”. Whereas customary polyesters are insufficiently flexible for use as protective colloids, comb polymers, owing to their variable physical characteristics and in some cases film-forming properties can be used as protective colloids in the microencapsulation of a large number of different water-insoluble and/or water-soluble active compounds.

The invention provides microencapsulated biologically active compounds comprising a water-soluble or water-dispersible comb polymer consisting of a main polymer chain and polyester side arms which carry sulfonic acid groups and are attached to the main polymer chain via ester groups. According to the invention, these comb polymers serve as protective colloids for the polymers which form the capsule wall of the microencapsulated active compounds.

The comb polymers used according to the invention are known from EP-1 035 194. According to the teaching of this prior art, they are used as soil release polymers in detergents.

Preference is given to comb polymers which are obtained by condensation

a) of a polycarboxylic acid or a polyalcohol,

b) of one or more unsubstituted or sulfo-substituted aliphatic, aromatic, araliphatic, polycyclic or cycloaliphatic alcohols having at least two OH groups or polyglycols of the formula HO—(XO)ₐ—(YO)_{c}—H, in which X and Y independently of one another are an alkylene group having 2 to 22, preferably 2 to 5, carbon atoms and a and c are numbers from 0 to 35, preferably from 0 to 5, where the sum of the coefficients has to be greater than or equal to 1,

c) of one or more unsubstituted or sulfonated C₂-C₁₀-dicarboxylic acids,

d) if appropriate, of “AB monomers”, which may also be sulfonated, based on aliphatic, aromatic, araliphatic, polycyclic or cycloaliphatic compounds which combine in their structure both OH and COOH functionalities,

e) of one or more compounds of the formulae NH₂R, NHR₂, ROH, R′COOH, HO(XO)_{b}—R, HO(CH₂CH₂)_{d}SO₃M in which R is C₁-C₂₂-alkyl or C₆-C₁₀-aryl, X is C₂H₄ and/or C₃H₇, b is a number from 3 to 40, preferably from 3 to 20, d is a number from 1 to 10, preferably from 1 to 4, and M is a cation, and also

f) if appropriate, of one or more silicon-containing compounds having one or more OH and/or COOH groups,

where at least one of the structural units mentioned under b) to e) must contain one or more sulfone groups.

The polymeric main chain of the comb polymers preferably consists of polymeric aliphatic, cycloaliphatic or aromatic polycarboxylic acids or derivatives thereof, such as, for example, polyacrylic acid, polymethacrylic acid, polymaleic acid, polymaleic anhydride and polynorbornenic acid or esters thereof with aliphatic, cycloaliphatic or aromatic C₁-C₂₂-alcohols. The number average molecular weights of these polycarboxylic acids may be between 1000 and 2,000,000 g/mol, with the range of 2000-100,000 g/mol being preferred.

Furthermore, the polymeric main chain may consist of a polymeric aliphatic, cycloaliphatic or aromatic polyalcohol, such as, for example, polyvinyl alcohol or polynorbornyl alcohol. The number average molecular weight of these polyalcohols may be between 1000 and 2,000,000 g/mol, the range of 2000 to 100,000 g/mol being preferred.

In addition, random, alternating or block-type copolymers of the two abovementioned classes of compounds with other vinylic monomers, such as, for example, styrene, acrylamide, α-methylstyrene, styrene, N-vinylpyrrolidone, N-vinylpyridine, N-vinylformamide, N-vinylcaprolactone, vinyl acetate or acrylamidopropylenesulfonic acid, vinylsulfonic acid, vinylphosphonic acid and the alkali metal, alkaline earth metal and ammonium salts thereof, may also be used.

These polycarboxylic acids and polyalcohols are reacted with a mixture of the components b) to d) as defined above, oligomeric polyester side chains forming. Suitable components b) are unsubstituted or sulfo-substituted aromatic, aliphatic or cycloaliphatic polyalcohols as defined above, for example ethylene glycol, 1,2-propanediol, 1,2-butanediol, polyalkylene glycols, 1,4-butanediol, sodium 1,2-dihydroxypropoxyethanesulfonate, glycerol, pentaerythritol.

The component c) comprises at least difunctional aromatic, aliphatic and/or cycloaliphatic C₂-C₁₀-dicarboxylic acids, such as, for example, terephthalic acid, isophthalic acid, cyclohexanedicarboxylic acid, succinic acid, adipic acid, 2,6-naphthalenedicarboxylic acid and optionally sulfonated aromatic, aliphatic or cycloaliphatic C₃-C₁₀-dicarboxylic acids, for example sulfosuccinic acid or 5-sulfoisophthalic acid (or alkali metal or alkaline earth metal salts thereof), dimethyl 5-sulfoisophthalate Na salt, or mixtures thereof.

To improve the solubility in water, in the case of the components containing sulfo groups, the sulfo group is preferably present as an alkali metal, alkaline earth metal or ammonium or mono-, di-, tri- or tetraalkyl- or -hydroxyalkyl-ammonium salt, it being possible for one alkyl group to contain 1 to 22 carbon atoms and the other alkyl groups, as well as the hydroxyalkyl group, to contain 1 to 4 carbon atoms.

Suitable AB monomers are, for example, hydroxycarboxylic acids, lactones, ε-caprolactam, amino acids or amino alcohols.

Component e) is a so-called endcap group. Suitable terminal groups of this type are:

aromatic, aliphatic or cycloaliphatic monoalkylamines or dialkylamines, it being possible for the alkyl group to contain 1 to 22 carbon atoms;

aromatic, aliphatic or cycloaliphatic monocarboxylic acids having 1 to 200 carbon atoms in the case of the aliphatic monocarboxylic acids and 6 to 10 carbon atoms in the case of the aromatic or cycloaliphatic monocarboxylic acids;

aliphatic monoalcohols having 1 to 22 carbon atoms or aromatic and cycloaliphatic monoalcohols having 6 to 10 carbon atoms;

polyalkoxy compounds of the formula HO(AO)ₓR, A being —C₂H₄— or —C₃H₇—, x being a number from 3 to 40, preferably from 3 to 20, and R being C₁-C₂₂-alkyl.

Sulfonated mono- or polyethylene glycols of the formula H(OCH₂CH₂)_{d}SO₃M, d being a number from 1 to 10, preferably from 1 to 4, and M being an alkali metal or alkaline earth metal cation, are particularly preferred as component e). The comb polymers according to the invention may alternatively also be free of components according to e).

Suitable silicon-containing components f) are all compounds which contain at least difunctional silicon and are capable of undergoing polycondensation under the chosen polymerization conditions. Difunctionalized polydimethylsiloxanes or diphenylsiloxanes having terminal OH and/or COOH groups, for example, can be employed advantageously. In addition, it is also possible to use oligomeric or monomeric silicon-containing compounds. Examples of these are dihydroxydiphenylsiloxane and dihydroxydimethylsiloxane. Further reactive derivatives, such as esters, anhydrides, etc., of the compounds described above are also included in the scope of the invention.

The comb polymers preferably comprise from 0.1 to 10% by weight of component a), from 10 to 80% by weight of component b), from 10 to 60% by weight of component c), from 0 to 50% by weight of component d), from 0.1 to 30% by weight of component e) and from 0 to 20% by weight of component f).

The number average molecular weights of the comb polymers may advantageously be between 2000 and 2,000,000 g/mol, particularly advantageously between 2000 and 100,000 g/mol, the range of 2000-30,000 g/mol preferably being used, very particularly advantageously 5000-15,000 g/mol.

The synthesis of the comb polymers is carried out by a process known per se, by first heating the components a) to f) at temperatures of from 160 to about 220° C. at atmospheric pressure with the addition of a catalyst. The reaction is then continued under reduced pressure at temperatures of from 160 to about 240° C. with removal of excess glycols by distillation. The known transesterification and condensation catalysts of the prior art, such as, for example, titanium tetraisopropoxide, dibutyltin oxide or antimony trioxide/calcium acetate, are suitable for the reaction. Regarding further details for carrying out the process, reference is made to EP 442 101.

According to the invention, these comb polymers are used as protective colloids in microencapsulation processes for biologically active compounds in amounts of from 1 to 20% by weight, preferably from 2 to 10% by weight.

The comb polymers used according to the invention can be employed on their own or in combination with emulsifiers.

Suitable nonionic emulsifiers are adducts of from 2 to 30 mol of ethylene oxide and/or from 0 to 5 mol of propylene oxide and linear fatty alcohols having 8 to 22 carbon atoms, fatty acids having 12 to 22 carbon atoms and mono-, di- and/or trialkylphenols having 8 to 15 carbon atoms in the alkyl group; C₁₂-C₁₈-fatty acid monoesters and diesters of adducts of from 1 to 30 mol of ethylene oxide and glycerol, glycerol monoesters and diesters and sorbitan/sorbitol monoesters and diesters of saturated and unsaturated fatty acids having 6 to 22 carbon atoms and their ethylene oxide adducts; adducts of from 15 to 60 mol of ethylene oxide and castor oil and/or hydrogenated castor oil, polyol esters, in particular polyglycerol esters, such as, for example, polyglycerol polyricinoleate and polyglycerol poly-12-hydroxystearate, carboxamides, for example N,N-dimethyl-decanecarboxamide, and also high-molecular-weight silicon compounds such as, for example, dimethylpolysiloxane having an average molecular weight of from 10 000 to 50 000. Also suitable are mixtures of compounds of a plurality of these substance classes. The weight ratio of comb polymer to nonionic emulsifier may be from 9:1 to 1:9, preferably from 4:1 to 8:1.

Also suitable for use as emulsifier are salts of a sulfuric acid monoester of an optionally alkoxylated alcohol, and also alkali metal and ammonium salts of linear or branched saturated or unsaturated alkyl sulfates having 8 to 22 carbon atoms, of alkylsulfonic acids (alkyl radicals: C₁₂-C₁₈) and of alkylarylsulfonic acids (alkyl radicals: C₉ to C₁₈), and also bis(phenolsulfonic acid) ethers and their alkali metal salts or ammonium salts which carry a C₄-C₂₄-alkyl group on one or both aromatic rings.

According to the invention, the sulfo-containing comb polymers are used as protective colloids in the preparation of microcapsule suspensions whose capsule wall consists of polyamide, polyurethane, polysulfonamide, polyurea, polyester, polyalcohol, polyimine, polycarbonate, polystyrene, polyacrylate, polymethacrylate, polysiloxane, polyterephthalate, PVC, urea/formaldehyde, melamine formaldehyde, melamine aminoplast, glycoluryl, aminoplast, polyerythrolamide, starch, pectin, cellulose, lectin, dextrin or cyclodextrin, gelatine, agar-agar, gum arabic and amino acids.

According to the invention, the sulfo-containing polyesters are also suitable for use as protective colloids for microencapsulation of water-insoluble and water-soluble active compounds by interphase polymerization (“in situ polymerization”) of polyamines and aldehydes, ureas and/or urea derivatives and aldehydes, isocyanates, in particular diisocyanates and triisocyanates, and diamines and polyamines, in particular aliphatic and alicyclic primary and secondary amines, for example ethylene-1,2-diamine, diethylenetriamine, triethylenetetramine, bis-(3aminopropyl)amine, bis(2-methylaminoethyl)methylamine, 1,4-diaminocyclohexane, 3-amino-1-methylaminopropane, N-methyl-bis-(3-aminopropyl)amine, 1,4-diamino-n-butane and 1,6-diamino-n-hexane, diols, for example ethanediol, propane-1,2-diol, propane-1,3-diol, butane-1,4-diol, pentane-1,5-diol, hexane-1,6-diol, glycerol and diethylene glycol, polyalcohols and/or aminoalcohols, for example triethanolamine, and also diols and polycarbonates.

Using the protective colloids used according to the invention, it is possible to microencapsulate water-insoluble and water-soluble liquids, solids having a low melting point (m.p.<80° C.) or solid substances dissolved in oil or water.

The active compounds enclosed in the microcapsules can be substances from the field of biologically active compounds, but in particular agrochemicals, such as fungicidally, insecticidally or herbicidally active compounds.

Here, preferred fungicidally active compounds are amino derivatives, such as 8-(1,1-dimethylethyl)-N-ethyl-N-propyl-1,4-dioxaspiro[4.5]decane-2-methamine (spiroxamine) and fenpropidin, and also morpholine derivatives, such as aldimorph, dodemorph and fenpropimorph. Preferred insecticidally active compounds which may be mentioned are azinphos-methyl, azinphos-ethyl, bromophos-A, carbaryl, chlorpyriphos, chlorpyriphos M, diazinon, dichlorphos, fenitrothion, fonofos, ediphenphos, fenaminphos, isofenphos, malathion, mesulfenphos, methidathion, parathion A, parathion M, permethrin, pyrethrin, pirimiphos, profenofos, pyraclophos, tebupirimifos, betacyfluthrin, cyfluthrin, cypermethrin, transfluthrin, lambdacyhalothrin. Suitable herbicidally active compounds are alachlor, acetochlor, butachlor, metazachlor, metolachlor, petrilachlor and propachlor, pendimethalin, glyfosate, atrazine, paraquat.

Additives which may be contained in the microcapsule formulations are, in addition to the comb polymers used according to the invention as protective colloids and the emulsifiers already described, organic solvents, thickeners, preservatives, antifoams, buffers, low-temperature stabilizers and neutralizing agents. Suitable organic solvents are all customary organic solvents which, on the one hand, are poorly miscible with water and, on the other hand, dissolve the active compounds used effectively or form a suitable continuous phase. Aliphatic and aromatic hydrocarbons, optionally halogenated hydrocarbons, such as toluene, xylene, carbon tetrachloride, chloroform, methylene chloride, dichloroethane, and esters including ethyl acetate may be mentioned as being preferred. Suitable thickeners are all substances customarily used for this purpose, in particular Kelzan (thixotropic thickener based on xanthan), salicic acids and attapulgite. Suitable preservatives are, for example, Preventol and Proxel, and suitable antifoams are, for example, silane derivatives, such as polydimethylsiloxane, and magnesium stearate. Suitable low-temperature stabilizers are all substances which are customarily used for this purpose. Urea, glycerol and propylene glycol may be mentioned by way of example.

Suitable buffers are all customary acids and their salts. Phosphate buffer, carbonate buffer and citrate buffer may be mentioned as being preferred.

The following examples are meant to illustrate the subject matter of the invention in more detail, without limiting the invention to the examples.

### EXAMPLE

At 9-11° C., a mixture of 158.9 g of tebupirimphos, 3.03 g of toluene diisocyanate and 3.5 g of 2H-1,3,5-oxadiazine-3,4,6-(3H,5H)-trione-3,5-bis(6-isocyanatohex-1-yl) is dispersed at 8,000 rpm in 245.5 g of a 1% strength solution of polyester in water in a mixture with 0.1 g of a silicone antifoam. 3.6 g of a 50% by weight strength solution of diethylenetriamine in water are then added. The resulting reaction mixture is heated to 70° C. over a period of 2 hours and then kept at 70° C. for a further 4 hours, with slow stirring. After final cooling to room temperature, 500 g of a 2% by weight strength solution of Kelzan (thickener based on xanthan) in water are added.

The polyester used as protective colloid was prepared by condensation of the following monomers:

| | |
|---|---|
| 5-Sulfoisophthalic acid dimethyl ester sodium salt | 400 mmol |
| Isophthalic acid | 1600 mmol |
| Diethylene glycol | 1049 mmol |
| 1,2-Propanediol | 2568 mmol |
| Sulfo-containing glycol | 74 mmol |
| Polyacrylic acid | 3 g |
| Triethylene glycol | 1049 mmol |

Further examples of comb polymers which contain sulfo groups used according to the invention are compiled in the table below:

| SIM | IPA | DEG | PG | PA | SE 1 | 1,3 PG | TEG | CHDC | Gly | CHDM |
|---|---|---|---|---|---|---|---|---|---|---|
| 249 | 1749 | 4196 | 0 | 3.0 | 37 | 0 | 0 | 0 | 0 | 0 |
| 400 | 1600 | 1575 | 0 | 3.0 | 100 | 2568 | 0 | 0 | 0 | 0 |
| 400 | 1600 | 2098 | 0 | 3.0 | 100 | 2568 | 0 | 0 | 0 | 0 |
| 400 | 1600 | 1049 | 2568 | 3.0 | 74 | 0 | 1049 | 0 | 0 | 0 |
| 450 | 400 | 500 | 2000 | 3.0 | 74 | 0 | 0 | 1200 | 150 | 400 |
| 400 | 800 | 1575 | 2068 | 3.0 | 74 | 0 | 0 | 800 | 60 | 0 |

SIM = 3-Sulfoisophthalic acid dimethyl ester sodium salt
IPA = Isophthalic acid
PG = 1,2-Propanediol
DEG = Diethylene glycol
SE 1 = Sulfonate-containing glycol
PA = Polyacrylic acid
1,3-PG = 1,3-Propylene glycol
TEG = Triethylene glycol
CHDC = 1,4-Cyclohexanedicarboxylic acid
Gly = Glycerol
CHDM = 1,4-Cyclohexanedimethanol
all numbers are mmol, the numbers given for PA are in grams.

1. A microencapsulated biologically active compound, comprising a water-soluble or water-dispersible comb polymer consisting of a main polymer chain and polyester side arms which carry sulfonic acid groups and are attached to the main polymer chain via ester groups.

2. A microencapsulated biologically active compound as claimed in claim 1, comprising a comb polymer obtainable by condensation
a) of a polycarboxylic acid or a polyalcohol,
b) of one or more unsubstituted or sulfo-substituted aliphatic, aromatic, araliphatic, polycyclic or cycloaliphatic alcohols having at least two OH groups or polyglycols of the formula HO—(XO)ₐ—(YO)_{c}—H, in which X and Y independently of one another are an alkylene group having 2 to 22, preferably 2 to 5, carbon atoms and a and c are numbers from 0 to 35, preferably from 0 to 5, where the sum of the coefficients has to be greater than or equal to 1,
c) of one or more unsubstituted or sulfonated C₂-C₁₀-dicarboxylic acids,
d) if appropriate, of “AB monomers”, which may also be sulfonated, based on aliphatic, aromatic, araliphatic, polycyclic or cycloaliphatic compounds which combine in their structure both OH and COOH functionalities,
e) of one or more compounds of the formulae NH₂R, NHR₂, ROH, R′COOH, HO(XO)_{b}—R, HO(CH₂CH₂)_{d}SO₃M in which R is C₁-C₂₂-alkyl or C₆-C₁₀-aryl, X is C₂H₄ and/or C₃H₇, b is a number from 3 to 40, preferably from 3 to 20, d is a number from 1 to 10, preferably from 1 to 4, and M is a cation, and also
f) if appropriate, of one or more silicon-containing compounds having one or more OH and/or COOH groups,
where at least one of the structural units mentioned under b) to e) must contain one or more sulfone groups.

3. A microencapsulated biologically active compound as claimed in claim 1, comprising a comb polymer obtainable by condensation of from 0.1 to 10% by weight of component a), from 10 to 80% by weight of component b), from 10 to 60% by weight of component c), from 0 to 50% by weight of compound d), from 0.1 to 30% by weight of component e) and from 0 to 20% by weight of component f).

4. A microencapsulated biologically active compound as claimed in claim 1, comprising a comb polymer whose main polymer chain is polyacrylic acid, polymethacrylic acid, polymaleic acid, polymaleic anhydride, polynorbornenic acid or C₁-C₂₂-esters thereof, polyvinyl alcohol or polynorbornyl alcohol.

5. A microencapsulated biologically active compound as claimed in claim 1, comprising a comb polymer whose polymer side groups contain terephthalic acid, isophthalic acid, cyclohexanedicarboxylic acid, succinic acid, adipic acid, 2,6-naphthalene dicarboxylic acid, sulfosuccinic acid or 5-sulfoisophthalic acid.
